(19) United States
(12) Patent Application Publication
(10) Pub. No.: US 2004/0036266 A1
(43) Pub. Date: Feb. 26, 2004

(54) Modular frame for transportation vehicle having depressed flatbed

(76) Inventor: Gian Paolo Tardini, Novi di Modena (IT)

Correspondence Address: GRAYBEAL, JACKSON, HALEY LLP, 155 - 108TH AVENUE NE, SUITE 350, BELLEVUE, WA, 98004-5901, US

(21) Appl. No.: 10/226,643

(22) Filed: Aug. 23, 2002

(51) Int. Cl. B62D 21/12

(52) U.S. Cl. 280/785

(57) ABSTRACT

The modular frame for transportation vehicles with depressed flatbed comprises a front wheel assembly with a steering wheel assembly, a rear wheel assembly with a fixed wheel assembly, a protruding front structure, a protruding rear structure and a central structure between the wheel assemblies. The aforesaid structures can be connected in a removable and non-removable way to said wheel assemblies upon assembly with the same type of attachment, eventually also using a disconnectable connection on the protruding rear structure of the bus frame and non-removable permanent connections on the other attachments between the wheel assemblies and the respective frame structure. In addition, the frame structure consists of central beams, lateral box-type beams and intermediate and end ribs. In the wheel assembly attachment area, the frame structure is equipped with flanges that can be coupled with similar flanges on the wheel assembly to which it must be permanently connected in a non-removable way.

### CROSS-REFERENCE TO RELATED APPLICATIONS

This application claims priority benefits from PCT/IT00/00540, filed Feb. 22, 2001, under 35 U.S.C. § 120. This application also claims priority benefits from the priority Italian application MO2000A000027, filed Feb. 23, 2000, upon which the PCT application derives. Both references are incorporated herein by reference.

### TECHNICAL FIELD OF THE INVENTION

The invention concerns a modular frame for transportation vehicles with a depressed flatbed, namely a new specific structure for land transportation vehicle frames, and specifically for buses and trucks. It makes it possible to increase productivity and the variety of vehicle types that can be manufactured with a reduced stock of parts.

### BACKGROUND OF THE INVENTION

Prior art includes frames with front and/or rear wheel assemblies with unsprung axles or structures that link the oscillation of the two wheels in the assembly with independent suspensions, such as anti-roll bars.

Moreover, existing frames present suspension members developed in height and occupying the usable passenger or freight space, thereby imposing a limited use of the respective overlying volume on the part of builders.

In addition, some existing frames consist of pre-formed depressed flatbeds housing the suspension members of the above-mentioned wheel assemblies. Moreover, said flatbeds are not modular and they can be initially constructed only in a very precise size and/or capacity load.

Furthermore, prior art includes frame embodiments that are supporting frames together with the body frame to create a sole, unchangeable structure.

Prior art, also, includes patent No. DE 31 51 280 A, which discloses a modular frame for transportation vehicles with a flatbed, including a front wheel assembly with a steerable wheel assembly, a rear wheel assembly with a fixed wheel assembly, a protruding front structure, a protruding rear structure and the central structure between the wheel assemblies. This type of frame allows the change of the length from the two wheel assemblies, but does not realize a modularization of the frame and does not allow the depressed flatbed, as the central structure is maintained at larger height from upper and lower components. Thus it is not possible to realize modern frames, i.e. depressed, with this frame conformation.

From what has been said so far, the necessity arises of solving the technical problem of finding a frame configuration that can be easily changed and adapted to the specific requirements of the vehicles requested by the end users. Therefore, it is necessary to find a frame and wheel assembly configuration that is capable of taking into account the widest and most rigorous standardization of the component parts themselves.

This state of the art is susceptible to remarkable improvements with a particular focus on the possibility of freeing manufacturers of frames and vehicles from foreseeing exactly and previously the type of vehicle to be constructed.

### SUMMARY OF THE INVENTION

This invention solves the engineering problem described above by adopting: a modular frame for transportation vehicles with a depressed flatbed, including a front wheel assembly with a steering wheel assembly, a rear wheel assembly with a fixed wheel assembly, a protruding front structure, a protruding rear structure and a central structure between the wheel assemblies; characterized in that the modular frame presents said structures that can be connected in a rigid way to said wheel assemblies upon assembly with the same type of attachment; there is also a possibility for simultaneous use of a removable connection for the protruding rear structure of the frame on the transportation vehicle and permanentlconnections for the other attachments between the wheel assemblies and the respective frame structures.

Adopting, in the preferred embodiment: the central structure of the frame is made up of central beams, lateral box-type beams and intermediate ribs, and equipped with flanges in the wheel assembly attachment area that can be coupled with similar flanges on the wheel assembly to which it has to be rigidly joined.

Adopting, in another preferred embodiment: the protruding front and rear structures of the frame are made up of central beams, lateral box-type beams, internal transverse members and end transverse members, equipped with flanges in the wheel assembly attachment area that can be coupled with similar flanges on the wheel assembly to which they have to be rigidly joined.

Adopting, in another preferred embodiment: said wheel assemblies are made up of a central box-type structure, equipped with raised side parts serving to house the suspension connections. In the front and rear attachment area, the box-type structure is equipped with flanges that can be coupled with similar flanges on the other structures of the frame to which it has to be rigidly joined.

Adopting, in another preferred embodiment: the box-type structure of the wheel assemblies are equipped with attachments for the flexible/shock-absorbing elements positioned for the respective suspension; moreover, it presents the housing for the possible driving transmission to the wheels if they are driving wheels.

Adopting, in another preferred embodiment: attachment points are provided for the body parts that have to be connected to the respective part of the frame.

Adopting, in another preferred embodiment: said body attachment points consist of a bell connected to the respective frame part and of a corresponding bell-shaped protuberance fixed to the body part: a flexible element is centrally positioned in the coupling, that can be dismantled by a bolt.

Adopting, in another embodiment: the attachment area for connecting the frame structures to the respective wheel assembly consists of flanges arranged longitudinally to the vehicle's axis and interconnected in a rigid way; said flanges project out one towards the other from the respective, opposite transverse members of the wheel assembly and frame structure to be connected.

Adopting, in another preferred embodiment: the supporting body of the wheel assembly stub axles, with uniform configuration, differs in application in the driving wheels and/or steering wheels for the suspension and/or transmission attachments.

Adopting, in another embodiment: the suspension attachment for the steering wheel is applied on the body and consists of slanted pins inserted in a rigid way on the body itself.

Adopting, in another embodiment: the suspension attachment for the fixed wheel is applied on the body and consists of specially designed tabs, inserted in a rigid way on the body itself.

Adopting, finally, in an embodiment of a transportation vehicle with a modular frame, characterized by one or more of the preceding parts and in which the motor assembly presents an auxiliary traction motor connected to the transmission and to the combustion engine with a selectable transmission, of one or the other motor or both.

The advantages of this invention include: the composition of the frame parts of the vehicle proves to be more flexible in terms of the adaptation needs required by the end client. The frame in its component parts is assembled only at assembly time, whereas the pre-assembled parts or units can be applied in any case on more than one type of frame, for vehicles with different utilization needs.

Moreover, the reticulated incorporation of the frame parts allows for lighter weight and change options during assembly with the use of elements in sizes and dimensions suited to the capacity load requirements of the vehicle for which the frame is being built.

In addition, the front and rear wheel assemblies differ only in the specific constitution of the suspension arms, but not in the type of suspension. Both are articulated quadrilateral suspensions, in that the front steering wheel assemblies have the same attachments as the rear, road wheel assemblies, thereby permitting a standardization of the box-type structure supporting and connecting the other frame parts.

Therefore, the above-mentioned modular structure makes it possible to render damaged body parts replaceable as single components and also to replace the motor-transmission unit with identical replacement engines to reduce vehicle disuse to a minimum.

Lastly, even the mechanical parts, the most detailed such as the stub axle casings, are built in standard versions for the front, steering and even the rear road wheels, varying only in the suspension attachment with the body itself.

### BRIEF DESCRIPTION OF THE DRAWINGS

Some embodiments of this invention are illustrated, by way of example, in the drawings enclosed in which:

FIG. 1 represents the plan view of the transportation vehicle frame according to the invention, in this case a truck with the engine axis not aligned with the vehicle;

FIG. 2 shows an A-A sectional view of FIG. 1 serving to show the front axle unit, motorized in this case;

FIG. 3 represents the B-B sectional view of FIG. 1 representing the intermediate configuration of the frame;

FIG. 4 is the C-C sectional view of FIG. 1, with the rear axle unit, idle in this case;

FIG. 5 is the plan view of the frame of a transportation vehicle according to the invention, in this case a bus, with an engine transverse to the vehicle and housed in the rear: the sections indicated as A-A, B-B and C-C correspond to the sections appearing in the figures mentioned previously, when they have been changed to take into account a different type of motorization;

FIG. 6 shows the side view of the bus fame, also showing a further extension of the rear protuberance of the frame yielding an extension in length;

FIG. 7 is the side view of the truck frame with an eventual extension of the rear part of the frame;

FIG. 8 shows a different configuration of the truck frame with a greater wheelbase and without the rear protuberance;

FIG. 9 is a partial plan view of a truck with the motor unit housed on the longitudinal axis of the frame;

FIG. 10 is a partial D-D section of the frame shown in FIG. 9 also showing a part of one side of the body and its connection to the frame;

FIG. 11 shows the plan view of the part of the frame and body appearing in the preceding figure;

FIGS. 12 and 13 represent the section, limited to the center line, of the driving and steering wheel hub on a vertical plane, as well as the varying attachment parts for the suspension arms for an identical hub, but for an idle road wheel;

FIG. 14 offers a side view of the box-type structure of the wheel assembly, complete with the suspension attachments and other parts of the frame;

FIG. 15 represents a perspective view of the attachment area between the wheel assembly and a part of the frame, showing the attachment flanges with a riveted or bolted connection.

### DETAILED DESCRIPTION OF THE INVENTION

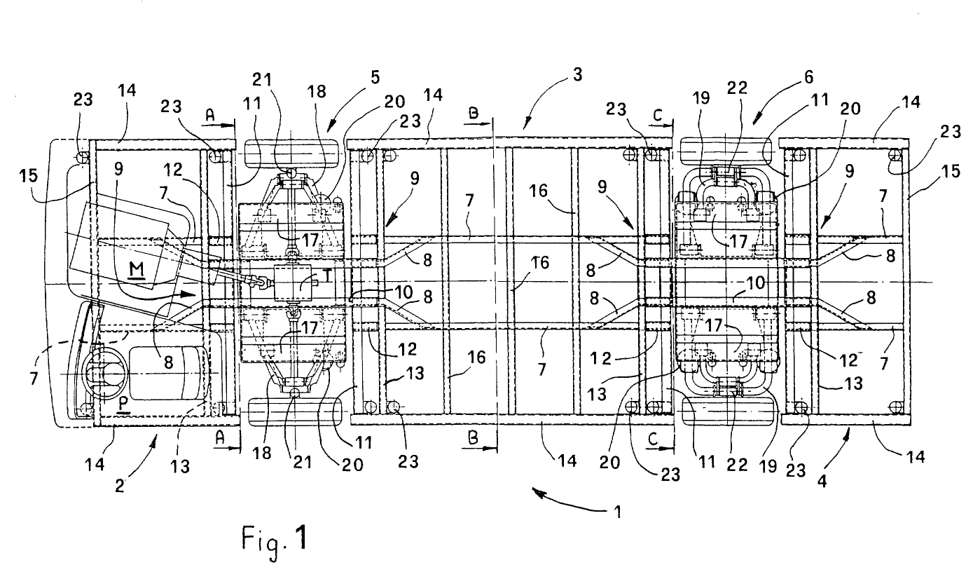

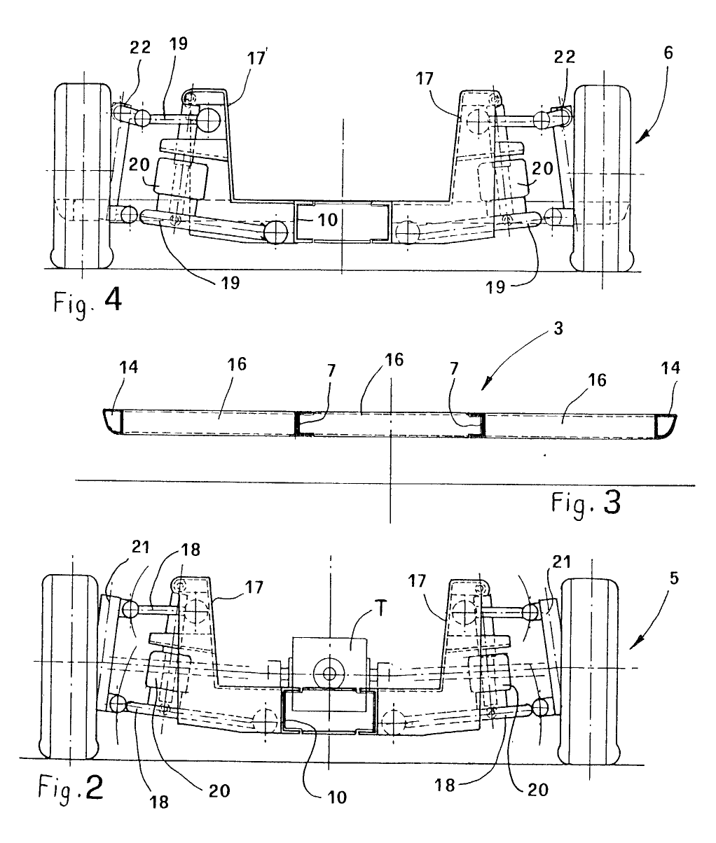

The following are indicated: 1 in FIG. 1, is the modular frame subdivided into five parts, of which 2 is the part with the front protuberance on the vehicle, 3 is the central part and 4 is the part with the rear protuberance; furthermore, 5 is the front steering-wheel assembly and 6 is the rear wheel assembly; in this case the front wheels are the driving wheels, but the frame does not change with the switch in the drive to the rear wheels; 7 indicates the central beams in each part of the frame, equipped with end braces 8 in the vicinity of said wheel assemblies, in the attachment area 9 for the box-type structure 10 of said wheel assemblies, in a transverse member 11 equipped with a flange 12 in said wheel assembly, and an internal transverse member 13 with flanged ends on said beams 7 and braces 8: said beams 7 and braces 8 are thus coupled in a removable way to the above-mentioned box-type structure 10; 14 indicates the lateral box-type beams on parts of the frame, 15 indicates the front and rear, terminal transverse members on the vehicle, 16 the intermediate ribs, 17 the raised part of the box-type structure housing the suspension, 18 front, steering or 19 rear, road referring to the respective wheel; 20 represents the flexible, shock-absorbing suspension element; 21 indicates the fulcrum in the steering wheel hubs, while 22 is the hub support for the road wheels; M is the power unit and T the transmission to wheels; P indicates the driver's seat, while 23 indicates the body structure and frame attachment points.

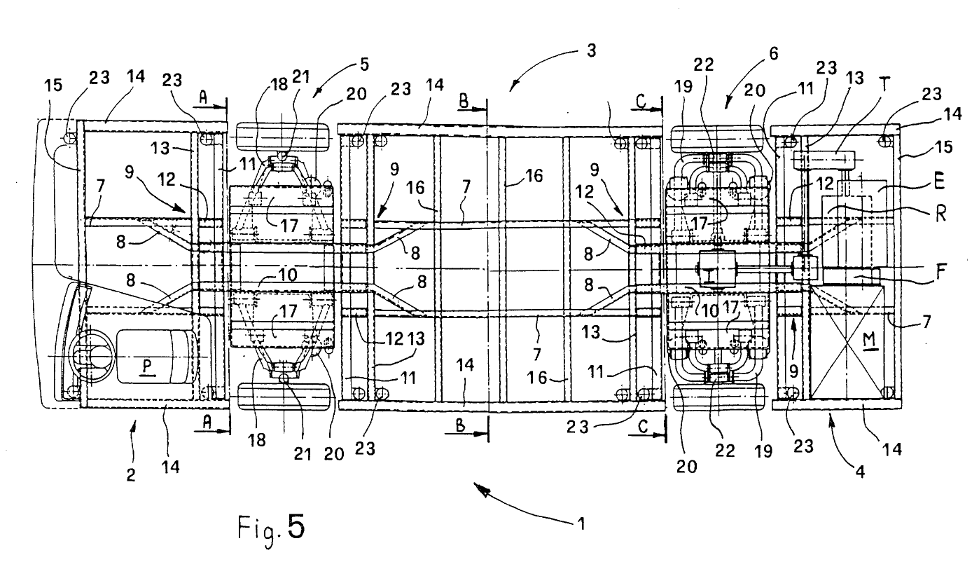

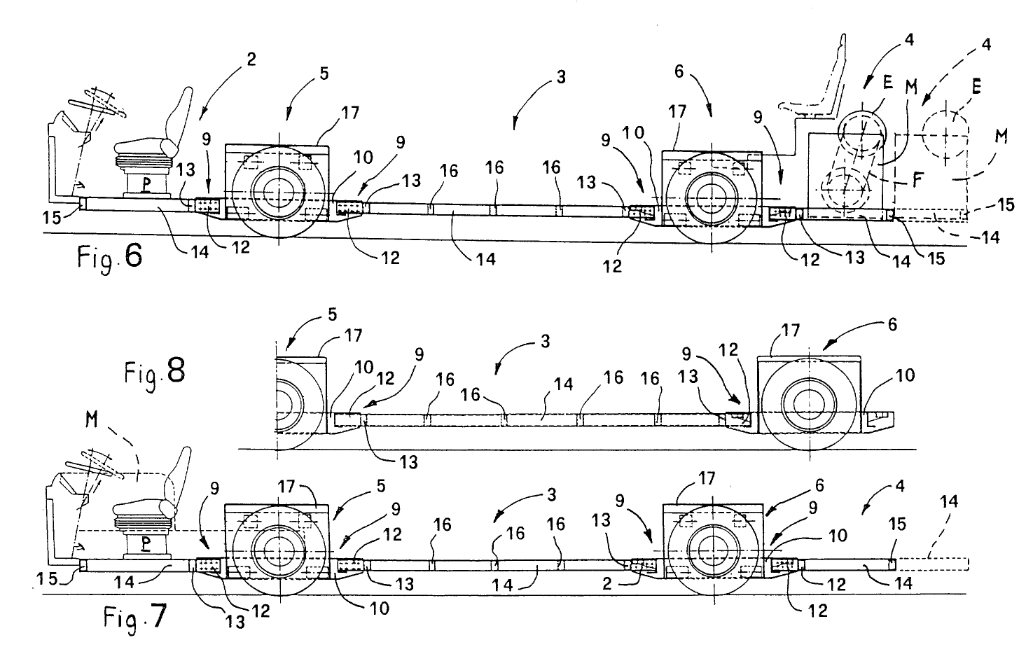

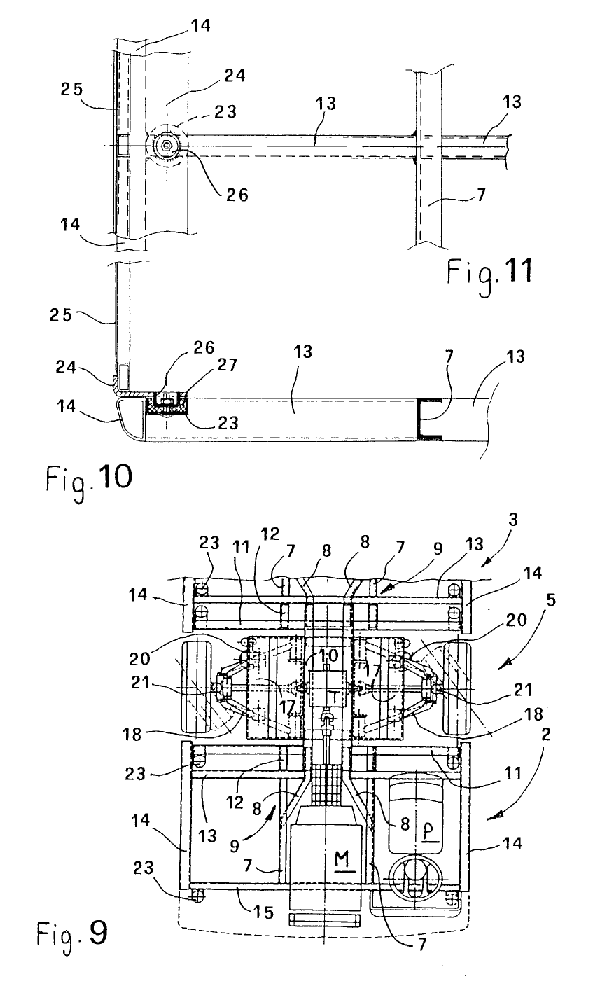

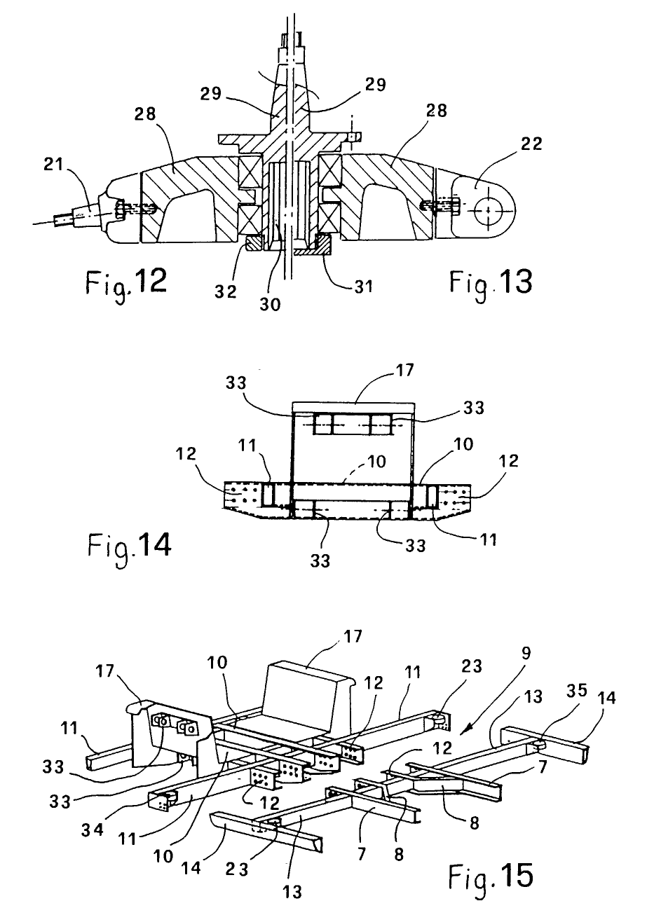

In addition, the following are also indicated: E, FIG. 5, is an electric traction and/or battery-charger motor serving for hybrid functioning of the vehicle, coupled with the combustion engine (M) by means of the transmission (F) with connection selection as desired by the driver; R is the change gear which can also be automatic; 24, FIG. 10, is the lower carling on the body 25, which in the vicinity of the points 23 features protuberances 26 that are fitted inside said points with the interposition of the flexible bell elements 27 and the respective fastening bolt; 28, FIG. 12, is the moving support casing for the fulcrums 21 for the steering wheel 18, or supports 22 for the road wheel 19, FIG. 13, connected with the suspensions of the respective front 5 and rear 6 wheel assemblies; 29 is the stub axle of the hub of the wheel rotating on said casing with rolling-contact bearings; 30 a splined opening for insertion of the axle shaft, if the respective wheel has to be a driving wheel; 31 is the locknut for said rolling-contact bearings with closure cap for the mouth of the splined 30, when the wheel must remain idle, and 32 is a nut serving only for tightening said bearings, when the axle shaft is inserted in said splined 30; 33, FIG. 14, are the attachments for suspension arms in the box-type structure 10, 17 in the wheel assembly; 34, FIG. 15, are the points of attachment of the part of the body on the wheel assembly structure and by 35, identical attachment points, but on the part of the frame that is connected to the wheel assembly: therefore all the attachment points 23 are sub-divided in 34, as part of the respective wheel assembly, and 35, as part of the respective part of the frame connected or connectable to the wheel assembly.

Use of the modular design of this invention is described in the following.

The manufacturers of frames for vehicles build the similar pieces for the various parts of the frame in bulk and only later, upon assembly, do they perfect the parts required by the specific type of vehicle requested.

The above-mentioned use permits the manufacturer to produce lots at low cost that are much larger than the lots normally produced with a conventional vehicle frame configuration.

Modifications in the vehicle structure are easily planned and carried out by changing the lengths of the frame beams: in this case, for greater frame base or protuberance lengths, larger beam dimensions are foreseen in order to support the greater stress exerted. In the same manner, greater demands on the vehicle in terms of capacity are met by adopting adequate beam dimensions.

Said production of the individual parts in bulk, without a specific frame objective, makes it possible to keep in stock the least amount of pieces for those same parts, while the manufacturer is still able to diversify the type of vehicles to put under assembly rapidly in order to meet the current needs of customers. This also means that there is no need to tie up large sums of money in component parts intended only for one specific use in a certain type of frame.

The practical outcome yields greater flexibility of the production of modular frames with depressed flatbeds according to the invention, compared to similar frames. The manufacturer can thus invest less capital in the stock of parts making up the frame, with the certainty of being able to use these same parts in all or almost all of the vehicle types proposed for sale and in the least amount of time possible.

The standardization mentioned above also makes it possible to render the body parts removable from the frame if repairs are needed: the damaged body part can be repaired separately if necessary, while the vehicle can be used in even less time by assembling an identical body part that has been re-conditioned or is new.

In this logic, making the motor unit removable from the vehicle proves to be very convenient for maintenance and/or repair work that may become necessary. For buses this feature is quite beneficial. The motor unit-rear transmission, M, R and T or M, F, E, R and T, can be detached from the vehicle frame by directly removing the flanges 12, when they are coupled with bolts, in the respective attachment area 9 of the frame part 4 in FIG. 5. The maintenance shop can thus make the necessary repairs on the motor-transmission unit without keeping the vehicle occupied, for at that same time, they will have assembled an identical motor-transmission unit as replacement.

In conclusion, the large-scale production of these same standardized parts allows for rapid replenishment, with non small quantity lots and thus reduced production costs. This leads to the synergy of the production of the parts of the vehicle frame, while also maintaining a high level of versatility in terms of the specifications of customers.

From the foregoing description, it will be appreciated that, although specific embodiments of the invention have been described herein for purposes of illustration, various modifications may be made without deviating from the spirit and scope of the invention. Accordingly, the invention is not limited except as by the appended claims.

I claim:

1. Modular frame for transportation vehicles with a depressed flatbed, including a front wheel assembly with a steering wheel assembly, a rear wheel assembly with a fixed wheel assembly, a protruding front structure, a protruding rear structure and a central structure between the wheel assemblies; characterized in that the modular frame presents said structures that can be connected in a rigid way to said wheel assemblies upon assembly with the same type of attachment; there is also a possibility for simultaneous use of a removable connection for the protruding rear structure of the frame on the bus and permanently connections for the other attachments between the wheel assemblies and the respective frame structures.

2. Modular frame for vehicles, according to claim 1, characterized in that said frame presents the central structure of the frame made up of central beams, lateral box-type beams and intermediate ribs, and equipped with flanges in the wheel assembly attachment area that can be coupled with similar flanges on the wheel assembly to which it has to be rigidly joined.

3. Modular frame for vehicles, according to claim 1, characterized in that said frame presents the protruding front and rear structures of the frame made up of central beams, lateral box-type beams, internal transverse members and end transverse members, equipped with flanges in the wheel assembly attachment area that can be coupled with similar flanges on the wheel assembly to which they have to be rigidly joined.

4. Modular frame for vehicles, according to claim 1, characterized in that said wheel assemblies are made up of a central box-type structure, equipped with raised side parts serving to house the suspension connections; in the front and rear attachment area, the box-type structure is equipped with flanges that can be coupled with similar flanges on the other structures of the frame to which it has to be rigidly joined.

5. Modular frame for vehicles, according to claim 4, characterized in that said frame presents the box-type structure of the wheel assemblies equipped with attachments for the flexible/shock-absorbing elements positioned for the respective suspension; moreover, it presents the housing for the possible wheel transmission if the wheels are driving wheels.

6. Modular frame for vehicles, according to claim 1, characterized in that attachment points are provided for the body parts that have to be connected to the respective part of the frame.

7. Modular frame for vehicles, according to claim 2, characterized in that attachment points are provided for the body parts that have to be connected to the respective part of the frame.

8. Modular frame for vehicles, according to claim 3, characterized in that attachment points are provided for the body parts that have to be connected to the respective part of the frame.

9. Modular frame for vehicles, according to claim 4, characterized in that attachment points are provided for the body parts that have to be connected to the respective part of the frame.

10. Modular frame for vehicles, according to claim 6, characterized in that said body attachment points consist of a bell connected to the respective frame part and of a corresponding bell-shaped protuberance fixed to the body part: a flexible element is centrally positioned in the coupling, that can be dismantled by a bolt.

11. Modular frame for vehicles, according to claim 2, characterized in that said frame presents the attachment area for connecting the frame structures to the respective wheel assembly consisting of flanges arranged longitudinally to the vehicle's axis and interconnected in a rigid way; said flanges project out one towards the other from the respective, opposite transverse members of the wheel assembly and frame structure to be connected.

12. Modular frame for vehicles, according to claim 3, characterized in that said frame presents the attachment area for connecting the frame structures to the respective wheel assembly consisting of flanges arranged longitudinally to the vehicle's axis and interconnected in a rigid way; said flanges project out one towards the other from the respective, opposite transverse members of the wheel assembly and frame structure to be connected.

13. Modular frame for vehicles, according claim 4, characterized in that said frame presents the attachment area for connecting the frame structures to the respective wheel assembly consisting of flanges arranged longitudinally to the vehicle's axis and interconnected in a rigid way; said flanges project out one towards the other from the respective, opposite transverse members of the wheel assembly and frame structure to be connected.

14. Modular frame for vehicles, according to claim 1, characterized in that the supporting body of the wheel assembly stub axles, with uniform configuration, differs in application in the driving wheels and/or steering wheels for the suspension and/or transmission attachments.

15. Modular frame for vehicles, according to claim 2, characterized in that the supporting body of the wheel assembly stub axles, with uniform configuration, differs in application in the driving wheels and/or steering wheels for the suspension and/or transmission attachments.

16. Modular frame for vehicles, according to claim 3, characterized in that the supporting body of the wheel assembly stub axles, with uniform configuration, differs in application in the driving wheels and/or steering wheels for the suspension and/or transmission attachments.

17. Modular frame for vehicles, according to claim 4, characterized in that the supporting body of the wheel assembly stub axles, with uniform configuration, differs in application in the driving wheels and/or steering wheels for the suspension and/or transmission attachments.

18. Modular frame for vehicles, according to claim 14, characterized in that said frame presents the suspension attachment for the steering wheel applied on the body and consists of slanted pins inserted in a rigid way on the body itself.

19. Modular frame for vehicles, according to claim 14, characterized in that said frame presents the suspension attachment for the fixed wheel is applied on the body and consists of specially designed tabs, inserted in a rigid way on the body itself.

20. Transportation vehicle equipped with modular frame for vehicles, according to claim 1, in which the motor unit presents an auxiliary traction motor connected to the transmission and to the combustion engine with a selectable transmission, of one or the other motor or both.
